(19) United States
(12) Patent Application Publication
(10) Pub. No.: US 2020/0028340 A1
(43) Pub. Date: Jan. 23, 2020

(54) COVER PLATE WITH CIRCUIT LABEL OPENING

(71) Applicant: Peter Calvert, London (CA)

(72) Inventor: Peter Calvert, London (CA)

(21) Appl. No.: 16/517,844

(22) Filed: Jul. 22, 2019

Related U.S. Application Data
(60) Provisional application No. 62/816,266, filed on Mar. 11, 2019.
(60) Provisional application No. 62/746,526, filed on Oct. 16, 2018.
(60) Provisional application No. 62/701,089, filed on Jul. 20, 2018.

(51) Int. Cl. H02G 3/08; H02G 3/14; H01H 9/02; H01H 9/18; H01R 13/46

(52) U.S. Cl. CPC H02G 3/081; H02G 3/14; H01R 13/465; H01H 9/18; H01H 9/02

(57) ABSTRACT

A plate for covering an electrical box comprising a face larger in height and width than the electrical box, an opening in the face capable of having an insert slidably placed into the opening, wherein the insert is at least partially obscured when placed into the opening, and the insert has thereon printed indicia that specify a device to which the electrical box is associated or color information of an adjacent surface.

### CROSS-REFERENCE TO RELATED PATENT APPLICATIONS

The application claims the benefit of U.S. Provisional Application No. 62/701,089, filed on Jul. 20, 2018, U.S. Provisional Application No. 62/746,526, filed on Oct. 16, 2018 and U.S. Provisional Application No. 62/816,266, filed on Mar. 11, 2019. The complete disclosures of U.S. Provisional Application Nos. 62/701,089, 62/746,526 and 62/816,266 are incorporated herein by reference.

### FIELD

The present disclosure relates to a plate for covering an electrical box and in particular to a cover plate equipped with a mechanism for identifying a circuit breaker, or communication device associated with an electrical box.

### BACKGROUND

When servicing electrical systems, it is necessary to disconnect components from electrical circuits for safety purposes. Components are disconnected by switching off a circuit breaker at a central panel, disabling only certain circuits, minimizing service impact. It is sometimes difficult to determine which circuit breaker is associated with a certain device. Breaker panels often include a labelling area, where an operator can associate circuit breaker numbers to different devices, frequently in the form of handwritten notes. Generally, electrical boxes have no associated identifying tag. It is often unclear to what the information entered into the labelling area refers. Operators sometimes use general location descriptions to identify electrical boxes associated with specific circuit breakers. This general location description can be imprecise, sometimes resulting in the wrong circuit breaker being identified. This is both a safety and efficiency concern. To avoid this, operators can assign codes to electrical boxes. These codes can be recorded in the central panel labelling area, providing a more certain reference to those accessing the information in the labelling area. These codes must also be attached to electrical boxes. Current methods to fix these labels include externally applied labels and internal labels that require a certain level of disassembly to access. It would be advantageous if this circuit breaker association information was accessible without disassembly or the use of tools, while remaining out of view when not needed. This information could be a label applied to an electrical box, that is to be cross referenced at the central panel labelling, or this label could directly reference the identity of a specific circuit breaker.

An analogous issue exists with other components mounted in electrical boxes, such as coaxial connectors or Ethernet ports. It is sometimes difficult for an operator to determine what the other end of an Ethernet, coaxial or other communication port is mounted to without significant investigation. It would be advantageous if this network information was readily accessible, with minimal disassembly.

Similarly, coverplates may be mounted on painted surfaces. It is sometimes necessary to perform maintenance that requires paint touch ups of these painted surfaces. In order to avoid repainting the entire painted surface, an operator is required to use a paint of the exact same shade to properly match the existing surface. To acquire paint of the same shade, paint specification information is required. It would be advantageous if this paint specification information was readily accessible, with minimal disassembly.

Previous inventions in the field teach cover plates with integrated labelling mechanisms, or supplementary structures for labelling. Some prior art teaches a component that is installed under a cover plate that provides a surface for affixing labels that may refer to associated circuit breakers. Viewing this labelling surface requires removal of the cover plate, which generally requires tools. Other prior art teaches an electrical wall plate with a push on or snap on label carrier that indicates what electrical component the cover plate is associated with. These label carriers could be printed with indicia that identify the circuit breaker associated to an electrical box. The label components are always externally visible. Also currently known is a labelling component that can be affixed to a cover plate using the same mounting hardware that affixes the cover plate to an electrical box. This labelling component comprises a label frame that attaches to the coverplate, in which a label can be placed. On top of this label, a transparent window can be attached, fixing the label in place. This provides a label that is always visible and accessible without disassembly.

The prior art teaches cover plates that provide an externally visible labelling method, or a non-visible labelling method for electrical boxes, that requires disassembly to access labels. It would be advantageous to have labels usually obscured for aesthetic purposes, while allowing access to labels without removal of the cover plate from the electrical box, or other significant disassembly.

### SUMMARY

According to some aspects, the invention comprises a plate for covering an electrical box comprising a face larger in height and width than the electrical box and an opening in the face capable of having an insert slidably placed into it. When the insert is placed into the opening, it is at least partially obscured. The insert has thereon printed indicia that can identify a circuit breaker, or communication device to which the electrical box is associated or color information of an adjacent surface.

According to some aspects, the opening is equipped with a push-push mechanism that assists in extraction of the insert from the opening. According to some aspects, the insert comprises a raised ridge, assisting in extraction from the slot. In some aspects, the insert is shaped like a memory card.

According to some aspects, the opening can have a height of about 2 mm and a width of about 15 mm. The opening may have a depth of about 14 mm.

According to some aspects, the cover plate further comprises a mounting mechanism that allows the plate to be installed on an external surface. According to some aspects, the mounting mechanism comprises at least one hole through the face for inserting a mechanical fastener. In other aspects, the mounting mechanism comprises an area on which an adhesive may be applied to engage with the external surface, fixing the plate to the external surface.

According to some aspects, the cover plate comprises at least one aperture through the face that provides access to an electrical component situated in the electrical box when the plate is installed on the external surface. In some aspects, the electrical component is an electrical outlet or switch.

Other features and advantages of the present application will become apparent from the following detailed description taken together with the accompanying drawings. It should be understood, however, that the detailed description and the specific examples, while indicating one or more embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a perspective view of an exemplary embodiment of a cover plate for a wall switch with circuit label opening.

FIG. 2 is a front view of the exemplary embodiment of a cover plate for a wall switch with circuit label opening. Included in the figure is the insert that can be placed into the opening.

FIG. 3 is a front view of the exemplary embodiment of a cover plate for a wall switch with circuit label opening. Included in the figure is the insert that can be placed into the opening.

FIG. 4 is a side view of the exemplary embodiment of a wall switch cover plate with circuit label opening.

FIG. 5 is a front view of an embodiment of a cover plate for a multi-gang wall switch box, with circuit label opening.

FIG. 6 is a front view of an embodiment of an electrical outlet cover plate with circuit label opening.

FIG. 7 is a detail view of an embodiment of an insert with indicia identifying an electrical circuit.

FIG. 8 is a detail view of an embodiment of an insert with indicia identifying a communication device.

FIG. 9 is a detail view of an embodiment of an insert with indicia identifying paint specification information of an adjacent surface.

FIG. 10 is a perspective view of an exemplary embodiment of a cover plate for a wall switch with circuit label opening according to one aspect.

FIGS. 11A-11C are perspective views of an exemplary embodiment of a cover plate for a wall switch with circuit label opening according to one aspect.

FIG. 12 is a perspective view of an exemplary embodiment of a cover plate for a wall switch with NFC tag according to one aspect.

FIG. 13 is a perspective view of an exemplary embodiment of a socket with wireless tag according to one aspect.

Further aspects and features of the example embodiments described herein will appear from the following description taken together with the accompanying drawings.

### DETAILED DESCRIPTION

Various systems, devices, or methods will be described below to provide an example of at least one embodiment of the claimed subject matter. No embodiment described herein limits any claimed subject matter and any claimed subject matter may cover systems, devices, or methods that differ from those described herein. The claimed subject matter is not limited to systems, devices, or methods having all of the features of any one process or device described below or to features common to multiple or all of the systems, devices, or methods described herein. It is possible that a system, device, or method described herein is not an embodiment of any claimed subject matter. Any subject matter that is disclosed in a system, device, or method described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling can have a mechanical, electrical, or optical connotation. For example, as used herein, the terms coupled or coupling can indicate that two or more elements or devices can be directly connected to one another or connected to one another through one or more intermediate elements or devices via an electrical element, electrical signal, optical signal, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should also be noted that terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about”, which means a variation of up to a certain amount of the number to which reference is being made if the end result is not significantly changed, such as 10%, for example.

The present disclosure provides apparatus and systems for covering electrical boxes and in particular to cover plates that provide a mechanism for identifying a circuit or communication device associated to the electrical box being covered. Additionally, this mechanism may identify color and paint information for an adjacent surface. The present disclosure provides a discussion of the use of a slot opening in an electrical box cover plate to allow for the storage of a labelling insert. Although the present disclosure provides a discussion of various mechanical and electrical concepts, these are provided to help in understanding the present disclosure and are not intended to be limiting. The present disclosure is not necessarily bound to any such discussed theories and/or calculations.

Challenges addressed by the present disclosure may include, among others, the challenges of affixing a label to a cover plate in an inconspicuous manner, while providing easy, tool-less access to this label.

In various example embodiments described herein, the present disclosure provides an alternative apparatus for covering electrical boxes, while providing access to an opening that can slidably accept an insert, wherein the insert is obscured when placed into the opening. This insert is printed with indicia that assist in identifying a circuit or communication device associated to the electrical box covered. The indicia may also identify color or paint information of an adjacent surface.

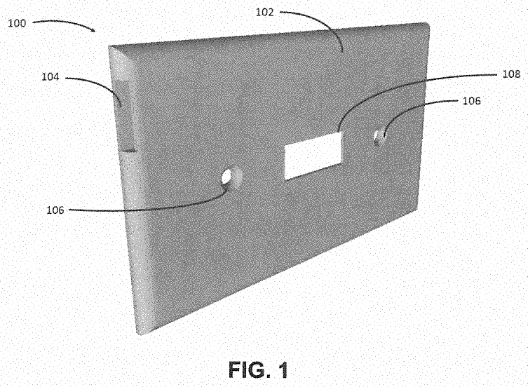

Referring now to FIG. 1, shown therein is a perspective view of an exemplary embodiment of a cover plate 100. The cover plate 100 comprises a face 102, with an opening 104 in the face in which an insert 110 may be slidably placed into. In this embodiment, the opening is of a slot shape, that is, with an opening width 116 that is significantly larger than the opening height 114. The embodiment of FIG. 1 is a cover plate for an electrical box containing a wall switch. Present in this embodiment is an aperture 108 in the face 102 that provides access to the wall switch in the electrical box. The embodied cover plate includes a mounting mechanism 106 comprising a pair of holes bored through the face 102 that can accept mechanical fasteners, which can be used to fix cover plate 100 over the electrical box.

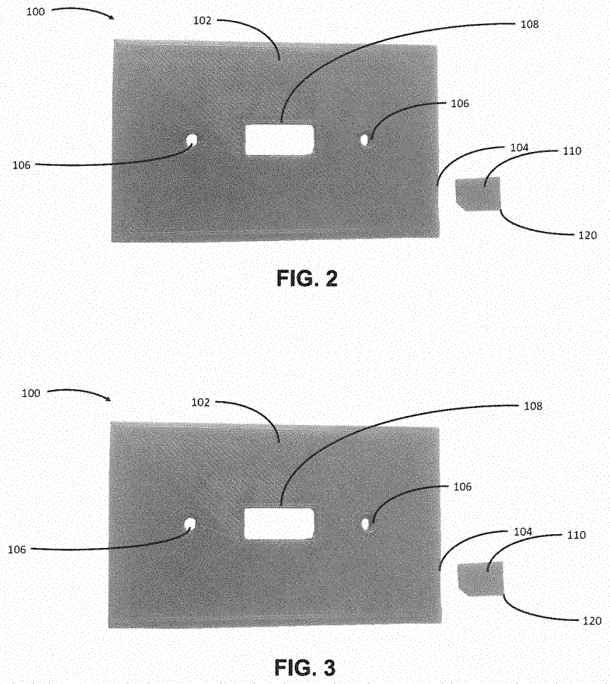

Referring now to FIG. 2, shown therein is a front view of the components of the exemplary embodiment of FIG. 1. FIG. 2. Includes an embodiment of an insert 110 that can be printed with indicia 122 that may identify a circuit, or communication device associated with the wall box that cover plate 100 is mounted over. Alternatively, indicia 122 may identify color or paint specification information of an adjacent surface.

These indicia 122 may take on many forms, depending on the method selected to identify the associated circuit. An operator may choose to assign a code to the cover plate. This code could then be entered into the labelling area of the central breaker panel at the time of installation. If maintenance is necessary, and an operator wishes to determine which circuit breaker is associated to the electrical box, they can remove the insert 110 from the cover plate 100, and read the printed indicia 122. Then, they may cross reference this code against the recorded information on the labelling area of the central breaker panel. This code may be found printed next to a numbered circuit breaker. The operator may switch the referenced circuit breaker into the “off” position, disabling the device contained in the covered wall box, allowing for safe maintenance.

Alternatively, the insert 110 may comprise printed indicia 122 that directly identify a circuit breaker associated to the electrical box. If maintenance is necessary, and an operator wishes to identify a circuit breaker associated to the electrical box, they may remove the insert 110 from the cover plate 100, and read the printed indicia 122. These indicia 122 may directly identify a breaker number, and if multiple panels are present, the panel number. The operator may then locate the panel and breaker identified, and switch off the circuit in question, rendering the electrical box safe for maintenance.

Indicia 122 may provide information regarding a communication device to which an electrical box is associated. Access points to wired coaxial or ethernet communication networks may be installed in electrical boxes. It is sometimes difficult to determine which communication device is associated with an electrical box. Indicia 122 may contain information, such as ethernet switch and port number or coaxial switch and port number, to provide an operator information required to make certain connections to, or to troubleshoot, communication networks.

Indicia 122 may provide paint specification information of a painted surface adjacent to cover plate 100. Painted surfaces may require periodic touch ups. It is ideal if the same shade of paint is used for these touch ups to maintain an aesthetic uniformity. Paint specification information may be required to acquire paint of an identical shade. An operator may access insert 110 in order to view paint specification information of indicia 122.

The insert 110 includes a raised ridge 120 to assist in the removal of the insert 110 from the opening 104. An operator may engage with this ridge 120, with the edge of a fingernail, tool or any other means, to facilitate the application of force in the direction opposite than that was used to slidably place the insert 110 into the opening 104.

Referring now to FIG. 3, shown is a front view of the exemplary embodiment of FIG. 1 and FIG. 2 switch cover plate 100, with the insert 110 partially placed into the opening 104. The insert 110 is slidably placed into opening 104, using a translating force, parallel to the plane of face 102.

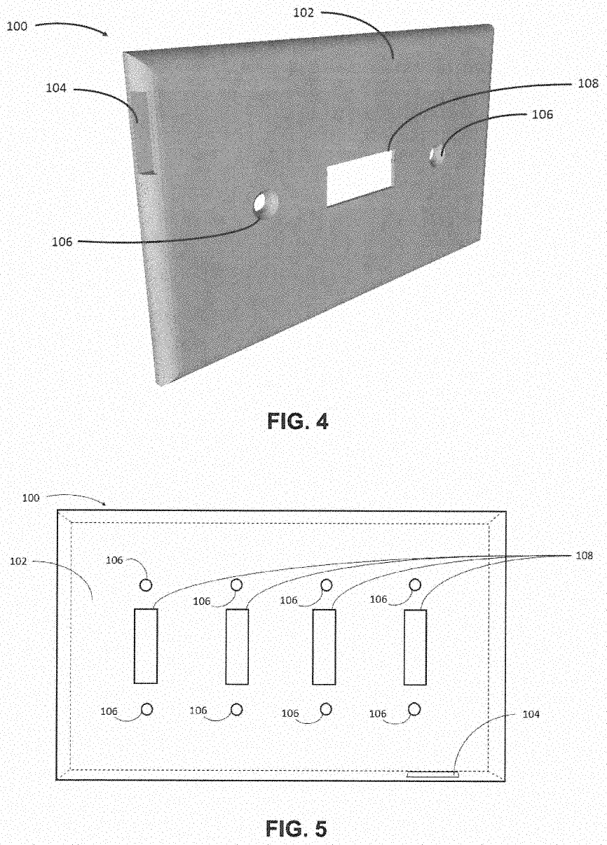

Referring now to FIG. 4, shown is a side vide of the exemplary embodiment of FIG. 1-3. Inside opening 104 is a push-push mechanism 112. The insert 110 is slidably placed into opening 104, using a translating force, parallel to the plane of face 102. To remove insert 110 from opening 104, the operator may invoke the assistance of push-push mechanism 112. In the embodiment of FIG. 1-4, when the insert is fully placed into the opening, the insert may slightly protrude from the opening. The operator may apply a force to the protruding portion of the insert, in the same translating direction as applied to the insert 110 to place the insert 110 into opening 104. The push-push mechanism 112 will accept this force, and then apply a force onto insert 110, in the opposite direction, along the same linear axis as the force used to slidably place the insert 110 into the opening 104. This reverse direction force at least partially ejects the insert 110 from the opening 104. This ejection either fully ejects the insert 110 from the opening 104, allowing the operator to access the printed indicia 122, or partially ejects the insert 110, providing a larger surface for the operator to engage with to provide force in the same direction as applied by the push-push mechanism 112, fully ejecting the insert 110, from the opening 104. Once ejected, the indicia 122 on the insert 110 can now be free accessed by the operator.

Referring now to FIG. 5, shown is a front view of an alternative embodiment of a cover plate 100, designed to cover an electrical box holding a four-gang wall switch assembly. The cover plate 100 comprises a face 102, with an opening 104 that can slidably accept an insert 110. Present on the face 102 are four apertures 108 that enable access to four wall switches mounted in the electrical box that the cover plate 100 is fixed to. Present on the face 104 are eight bored holes, comprising a mounting mechanism 106. Other embodiments may utilize a different mounting mechanism. These other mechanisms may include an adhesive based mechanism, where an adhesive is applied to the cover plate 100, on an area on the side reverse to the face 102. This adhesive may engage with an external surface, including but not limited to, a wall, floor, or electrical component, fixing the cover plate 100 to the external surface.

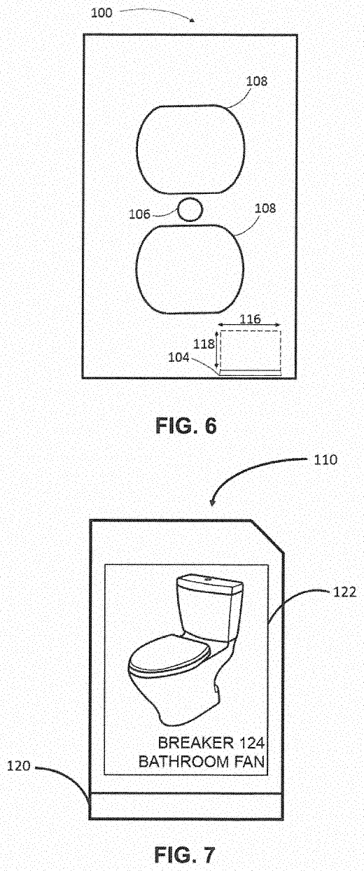

Referring now to FIG. 6, shown is a front view of an alternative embodiment of a cover plate 100, designed to cover an electrical box in which a single gang electrical outlet assembly had been installed. The cover plate 100 comprises a face 102, with an opening 104 that can slidably accept an insert 110. When the insert 110 is fully placed into opening 104, the insert 110 is at least partially obscured by face 102. Present on the face 102 are two apertures 108 that enable access to two electrical outlet ports mounted in the electrical box that the cover plate 100 is fixed to. Present on the face 104 are two bored holes, comprising a mounting mechanism 106. Shown in FIG. 6 is opening depth 118, which specifies the total length of the insert 110 that is obscured when placed into the opening 104.

Referring now to FIG. 7, shown is a detail view of an exemplary embodiment of an insert 110. The insert 110 is shaped like a memory card. The shape of a memory card may generally take the form of a rectangle, with one notched corner, such as the shape of a Secure Digital card, Subscriber Identity Module card or Micro Subscriber Identity Module card. Shown in FIG. 7 is the raised ridge 120 for removal, and indicia 122. In this embodiment, indicia 122 includes a pictorial representation of a toilet, to refer to a restroom. Indicia 122 further includes text that references a circuit breaker “BREAKER 124” to which the electrical box is associated.

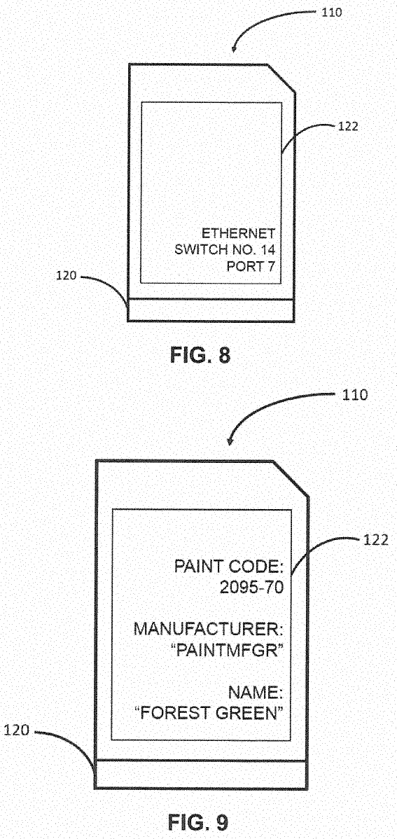

Referring now to FIG. 8, shown is a detail view of an exemplary embodiment of an insert 110. The insert 110 is shaped like a memory card. The shape of a memory card may generally take the form of a rectangle, with one notched corner, such as the shape of a Secure Digital card, Subscriber Identity Module card or Micro Subscriber Identity Module card. Shown in FIG. 8 is the raised ridge 120 for removal, and indicia 12. In this embodiment, indicia 122 includes text that references “ethernet switch no. 14” and “port 7” to which the electrical box is associated. In other embodiments, other pieces of reference information that assist an operator in identifying a communication device may be included.

Referring now to FIG. 9, shown is a detail view of an exemplary embodiment of an insert 110. The insert 110 is shaped like a memory card. The shape of a memory card may generally take the form of a rectangle, with one notched corner, such as the shape of a Secure Digital card, Subscriber Identity Module card or Micro Subscriber Identity Module card. Shown in FIG. 9 is the raised ridge 120 for removal, and indicia 122. In this embodiment, indicia 122 includes text that references paint specification information of an adjacent surface. In this embodiment, this information includes paint manufacturer, paint code and shade name. In other embodiments, different color specification information may be included.

In some embodiments, the cover plate 100 may be operable for wireless communication so as to be able to send information to a user (such as to a portable electronic device such as a tablet or a smartphone). In particulars, the cover plate 100 could include a wireless communication component for communicating with a portable electronic device. The wireless communication component could include, for example, an RFID tag (active or passive), an NFC tag, a Bluetooth module, WIFI module or other communication component.

In some embodiments, the wireless communication component could include its own UID (Unique ID). Using a smartphone or other device, the user can read the UID. In some cases, a user may be able to add additional information to the cover plate 100 via the wireless communication component, such as the placement of the cover plate 100, the type of load, the type of wire used so that this data can accumulate in a cloud or device-based database, and so on. In some cases, some or all of the additional information may be written to the actual tag itself as well as to a backend database.

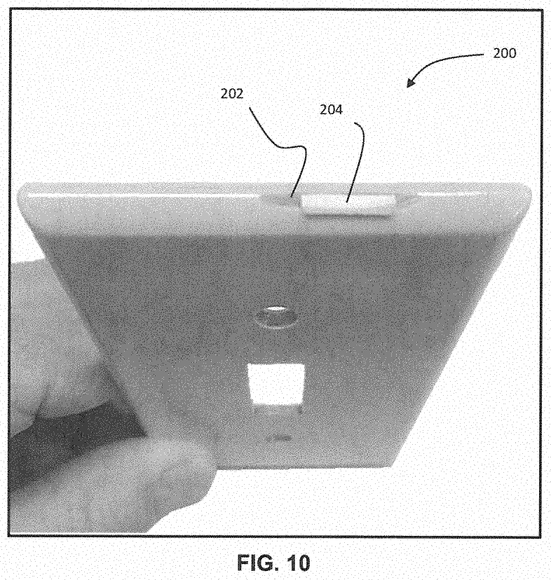

Turning now to FIG. 10, illustrated there is an exemplary embodiment of a cover plate 200 for a wall switch with circuit label opening according to another example. In particular, as show the cover plate 200 has a slit 202 in the top of the that is sized and shaped to receive a small tab 204 (which could be a plastic tab) upon which the breaker number or some other identifying information could be provided.

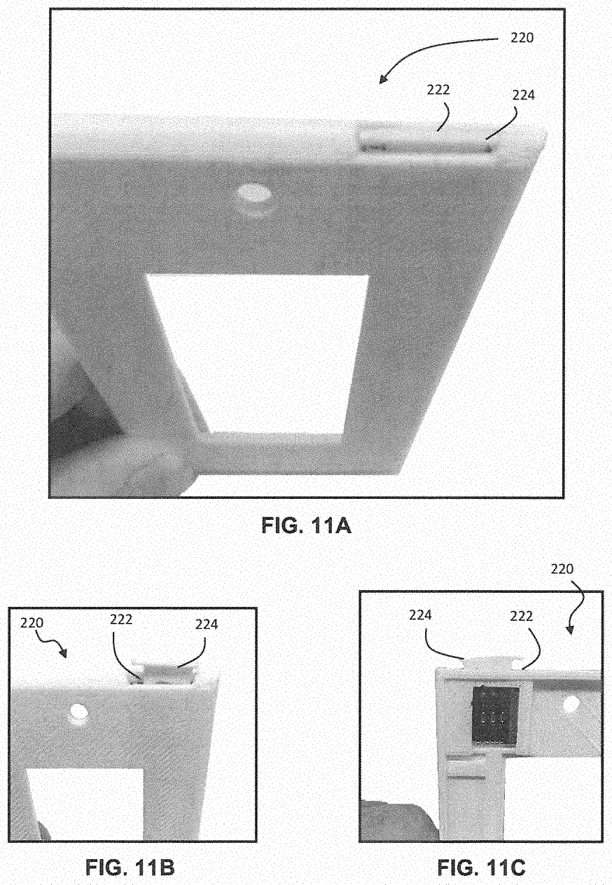

Turning now to FIGS. 11A-11B, illustrated therein are front perspective views of an exemplary embodiment of another cover plate 220 for a wall switch, while FIG. 11B similarly shows a rear perspective view of the cover plate 220. As shown the cover plate 220 includes a slot or opening 222 sized and shaped to receive a tab 224. In this embodiment, the tab 224 is sized and shaped to correspond to the size and shape of a SIM card holder, particularly a microSIM card holder. The opening 222 is configured to provide push-push functionality, in that the tab 224 can be pushed into the opening 222 to mount the tab 224 therein. Once inserted, the tab 224 can be pushed a further time to remove the tab 224 (i.e., the tab 224 will tend to spring back when pushed inwardly into the opening 222).

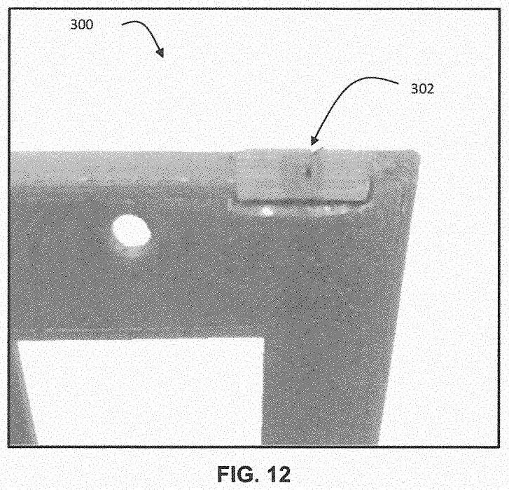

Turning now to FIG. 12, illustrated therein is a perspective view of a cover plate 300 for a wall switch with a wireless tag 302 (i.e., and RFID or NFC tag) according to one aspect. In particular, the wireless tag 302 could be a plastic tab that is also an NFC tag. In some cases, the wireless tag 302 may also include written material thereon.

In some embodiments, the cover plate 300 may be operable for wireless communication so as to be able to send information to a user (such as to a portable electronic device such as a tablet or a smartphone). In particulars, the wireless tag 302 on the cover plate 300 could for communicate with a portable electronic device. The wireless communication component could include, for example, an RFID tag (active or passive), an NFC tag, a Bluetooth module, WIFI module or other communication component.

In some embodiments, the wireless tag 302 could include its own UID. Using a smartphone or other device, the user can read the UID. In some cases, a user may be able to add additional information to the cover plate 300 via the wireless tag 302, such as the placement of the cover plate 300, the type of load, the type of wire used so that this data can accumulate in a cloud or device-based database, and so on. In some cases, some or all of the additional information may be written to the actual tag 302 itself as well as to a backend database.

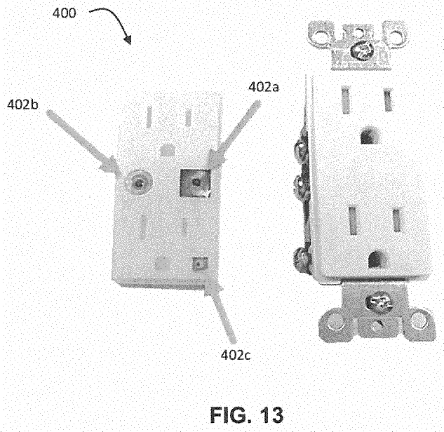

Turning now to FIG. 13, illustrated there is a perspective view of an exemplary embodiment of a socket 400 (i.e., an electrical wall socket, also sometimes called a wall plug) with a plurality of wireless tags 402a-c according to one aspect. In this specific example, the tags 402 and NFC tags of different sizes including a 9.5 mm diameter tag 402b, a 10×10 mm tag 402a, and a 5×5 mm tag 402c.

In some embodiments, the socket 400 may be operable for wireless communication so as to be able to send information to a user (such as to a portable electronic device such as a tablet or a smartphone). In particulars, the wireless tags 402a-c on the socket could for communicate with a portable electronic device. The wireless communication component could include, for example, an RFID tag (active or passive), an NFC tag, a Bluetooth module, WIFI module or other communication component.

In some embodiments, the wireless tags 402 could include their own UIDs. Using a smartphone or other device, the user can read the UID. In some cases, a user may be able to add additional information to the socket 400 via the wireless tags 402, such as the placement or location of the socket, the type of load, the type of wire used so that this data can accumulate in a cloud or device-based database, and so on. In some cases, some or all of the additional information may be written to the actual tags 402 as well as to a backend database.

In some embodiments, one or more tags 402 can be affixed to the socket 400, for example via an adhesive. In some embodiments, one or more tags 402 can be integrally formed with the socket 400.

In some embodiments, the socket 400 may include some printed indicia thereon.

The embodiments of the present disclosure described above are intended to be examples only and it is not intended that the applicant's teachings be limited to such embodiments. The present disclosure may be embodied in other specific forms. Alterations, modifications, and variations to the disclosure may be made without departing from the intended scope of the present disclosure. While the systems, devices, and processes disclosed and shown herein may comprise a specific number of elements/components, the systems, devices, and assemblies may be modified to include additional or fewer of such elements/components. For example, while any of the elements/components disclosed may be referenced as being singular, the embodiments disclosed herein may be modified to include a plurality of such elements/components. Selected features from one or more of the example embodiments described herein in accordance with the teachings herein may be combined to create alternative embodiments that are not explicitly described. All values and sub-ranges within disclosed ranges are also disclosed. The subject matter described herein intends to cover and embrace all suitable changes in technology. All references mentioned are hereby incorporated by reference in their entirety.

1. A plate for covering an electrical box comprising:
a face larger in height and width than the electrical box;
an opening in the face capable of having an insert slidably placed into the opening;
wherein the insert has thereon printed indicia; and
wherein the indicium is at least partially obscured when the insert is placed into the opening.

2. The plate of claim 1, wherein the indicia specifies a circuit breaker to which the electrical box is associated.

3. The plate of claim 1, wherein the indicia specifies a data or communication device to which the electrical box is associated.

4. The plate of claim 1, wherein the indicia specifies color information for an adjoining surface.

5. The plate of claim 1, wherein the opening is equipped with a push-push mechanism that assists in extraction of the insert from the opening.

6. The plate of claim 1, wherein the insert comprises a raised ridge that assists in extraction of the insert from the opening.

7. The plate of claim 1, wherein the opening has a height of about 2 mm and a width of about 12 mm.

8. The plate of claim 1, wherein the opening has a depth of about 15 mm.

9. The plate of claim 1, wherein the insert is shaped like a memory card.

10. The plate of claim 1, further comprising a mounting mechanism that allows the plate to be installed on an external surface.

11. The plate of claim 10, wherein the mounting mechanism comprises at least one hole through the face for inserting a mechanical fastener.

12. The plate of claim 10, wherein the mounting mechanism comprises an area on which an adhesive may be applied to engage with the external surface, fixing the plate to the external surface.

13. The plate of claim 10, further comprising at least one aperture through the face that provides access to an electrical component situated in the electrical box when the plate is installed on the external surface.

14. The plate of claim 13, wherein the electrical component is an electrical outlet or a switch.

15. The plate of claim 13, wherein the electrical component is a coupling for a coaxial cable.

16. The plate of claim 13, wherein the electrical component is a coupling for an ethernet cable.

17. A socket comprising at least one wireless tag for mobile communication.
